(19) United States
(12) Patent Application Publication
(10) Pub. No.: US 2024/0095694 A1
(43) Pub. Date: Mar. 21, 2024

(54) DYNAMICALLY GUIDING USERS TO REQUEST VALID PAYMENTS

(71) Applicant: Step Mobile, Inc., Palo Alto, CA (US)

(72) Inventor: Yu Hin LUNG, Palo Alto, CA (US)

(21) Appl. No.: 17/963,796

(22) Filed: Oct. 11, 2022

Related U.S. Application Data
(60) Provisional application No. 63/408,794, filed on Sep. 21, 2022.

(51) Int. Cl. G06Q 20/10; G06Q 20/22

(52) U.S. Cl. CPC G06Q 20/10; G06Q 20/227

(57) ABSTRACT

A method implemented by computer servers associated with a financial services platform includes receiving from an application executing on an electronic device, a request to initiate a payment of an amount of funds from a transferring user account to a recipient user account, and determining whether the payment can be satisfied by funds in a deposit account. In response to determining that the payment cannot be satisfied by funds in the deposit account, the method includes providing a prompt to switch from the deposit account to other connected accounts. In response to receiving confirmation to switch to the other connected accounts, the method includes causing the application to display a listing of the other connected accounts. The method further includes receiving a selection of at least one connected account, and updating the recipient user account in accordance with a value of the amount of funds.

### CROSS-REFERENCE TO RELATED APPLICATIONS

This application claims the benefit under 35 U.S.C. § 119(e) of U.S. Provisional Application No. 63/408,794, filed Sep. 21, 2022, which is incorporated herein by reference.

### TECHNICAL FIELD

This application relates generally to financial services platforms, and, more particularly, to a financial services platform for dynamically guiding users to request valid payments.

### BACKGROUND

Electronic payment systems may generally process millions or hundreds of millions of electronic payment and money transfers each day. In some instances, some of these electronic payment and money transfers may fail, thus leading to payment system and network inefficiencies and encumbrances on the part of users of the electronic payment systems. For example, in one instance, the electronic payment and money transfers may fail because a user's bank or card issuer may decline the electronic payment or money transfer for any number of potential common reasons. In another instance, the electronic payment and money transfers may fail because a user may have inadvertently attempted to execute an electronic payment or money transfer for a value of funds that the user does not currently have in her account. It may be useful to provide techniques to mitigate electronic payment and money transfer failures.

### SUMMARY

Embodiments of the present disclosure are directed toward a financial services platform including one or more computer servers and mobile payment application user interface for dynamically guiding users to request valid payments. In certain embodiments, the one or more computer servers may receive, from a first instance of an application executing on a first electronic device associated with a first user, a first request to initiate a payment of an amount of funds from a transferring user account to a recipient user account with the financial services platform. For example, in one embodiment, prior to receiving the first request to initiate the payment of the amount of funds, the one or more computer servers may cause the first instance of the application executing on the first electronic device associated with the first user to display a first affordance configured to cause the payment of the amount of funds to be initiated in response to a selection by the first user. In one embodiment, the recipient user account may be linked to the transferring user account. In one embodiment, the application may be associated with the financial services platform. In one embodiment, the transferring user account may include a deposit account, which may be configured to hold funds as collateral to secure repayment of balances corresponding to one or more spending accounts associated with the transferring user account.

In certain embodiments, the one or more computer servers may then determine whether the first request to initiate the payment of the amount of funds can be satisfied by at least a portion of the funds held in the deposit account. In certain embodiments, in response to determining that the payment of the amount of funds cannot be satisfied by at least the portion of the funds held in the deposit account, the one or more computer servers may then provide a second request to the first electronic device associated with the first user, in which the second request may include a prompt to switch from the deposit account to one or more connected accounts associated with the transferring user account. For example, in one embodiment, the one or more connected accounts may include one or more connected banking accounts or credit card accounts owned by the first user. The one or more computer servers may then receive, from the first instance of the application executing on the first electronic device associated with the first user, a confirmation to switch from the deposit account to the one or more connected accounts. In certain embodiments, in response to receiving the confirmation to switch from the deposit account to the one or more connected accounts, the one or more computer servers may then cause the first instance of the application executing on the first electronic device associated with the first user to display a listing of the one or more connected accounts.

In certain embodiments, in response to receiving a selection of at least one connected account of the listing of the one or more connected accounts, the one or more computer servers may then determine whether the first request to initiate the payment of the amount of funds can be satisfied by at least a portion of funds held in the at least one selected connected account. In certain embodiments, in response to determining that the request for the amount of funds can be satisfied by at least the portion of the funds held in the at least one selected connected account, the one or more computer servers may then update the recipient user account in accordance with a value of the amount of funds. For example, in one embodiment, updating the recipient user account may include updating the deposit account associated the recipient user account to reflect an increase in a balance of the deposit account associated the recipient user account in accordance with the value of the amount of funds. In one embodiment, updating the recipient user account may include updating the deposit account associated the recipient user account in response to receiving a confirmation to initiate the payment of the amount of funds from the transferring user account to the recipient user account.

In certain embodiments, in response to determining that the payment of the amount of funds can be satisfied by at least the portion of the funds held in the deposit account, the one or more computer servers may then update the transferring user account and the recipient user account to reflect an increase in a balance of the recipient user account in accordance with a value of the amount of funds to satisfy the payment of the amount of funds, and a decrease in the balance of the deposit account in accordance with the value of the amount of funds to satisfy the payment of the amount of funds. In certain embodiments, in response to determining that the request for the amount of funds cannot be satisfied by at least the portion of the funds held in the at least one selected connected account, the one or more computer servers may then provide a third request to the first electronic device associated with the first user, in which the third request includes a prompt to switch from the at least one selected connected account to another one of the one or more connected accounts. In certain embodiments, the one or more computer servers may then receive, from the first instance of the application executing on the first electronic device associated with the first user, a confirmation to switch from the at least one selected connected account to another one of the one or more connected accounts.

In certain embodiments, in response to receiving the confirmation to switch from the at least one selected connected account to another one of the one or more connected accounts, the one or more computer servers may then cause the first instance of the application executing on the first electronic device to redisplay the listing of the one or more connected accounts. In certain embodiments, while the first user inputs a value of funds corresponding to the first request to initiate the payment of the amount of funds, the one or more computer servers may then determine, based on the inputted value of funds, whether the first request to initiate the payment of the amount of funds can be satisfied by at least a portion of the funds held in the deposit account. In certain embodiments, in response to determining that the payment of the amount of funds cannot be satisfied by at least the portion of the funds held in the deposit account, the one or more computer servers may then cause the first instance of the application executing on the first electronic device associated with the first user to display a second affordance in place of the first affordance. For example, in one embodiment, the second affordance corresponds to the prompt to switch from the deposit account to the one or more connected accounts associated with the transferring user account.

In certain embodiments, while the first user inputs a value of funds corresponding to the first request to initiate the payment of the amount of funds, the one or more computer servers may then determine, based on the inputted value of funds, whether the first request to initiate the payment of the amount of funds can be satisfied by at least a portion of the funds held in the deposit account. In certain embodiments, in response to determining that the payment of the amount of funds can be satisfied by at least the portion of the funds held in the deposit account, the one or more computer servers may then cause the first instance of the application executing on the first electronic device associated with the first user to maintain display of the first affordance. In certain embodiments, the one or more computer servers may then receive, from the first instance of the application executing on the first electronic device associated with the first user, a selection of the first affordance. For example, in one embodiment, the selection of the first affordance may correspond to a confirmation of a completion of an input of a value of funds corresponding to the first request to initiate the payment of the amount of funds.

In certain embodiments, in response to receiving the selection of the first affordance, the one or more computer servers may cause the first instance of the application executing on the first electronic device to display a third affordance. For example, in one embodiment, the third affordance may correspond to a confirmation to initiate the payment of the amount of funds from the transferring user account to the recipient user account. In certain embodiments, in response to receiving the selection of the first affordance, the one or more computer servers may cause the first instance of the application executing on the first electronic device to display a fourth affordance. For example, in one embodiment, the fourth affordance may correspond to a confirmation to forgo initiating the payment of the amount of funds from the transferring user account to the recipient user account.

Indeed, the present techniques of providing a financial services platform including one or more computer servers for dynamically guiding users to request valid payments may provide technical improvements to previous or existing finance-related cloud-computing based platforms. For example, in accordance with the presently disclosed techniques, the financial services platform may provide technical improvements to previous or existing finance-related cloud-computing based platforms by streamlining the processing workload and database management that may be associated with such computing platforms through reducing the excessive calls to databases of the financial services platform that may be associated with failed payments.

### BRIEF DESCRIPTION OF THE DRAWINGS

FIG. 1 illustrates a financial services platform and network environment.

FIG. 2 illustrates a flow diagram of a method for dynamically guiding users to request valid payments.

FIGS. 3A-3H illustrate one or more running examples of a financial services platform and mobile payment application user interface for dynamically guiding users to request valid payments.

FIG. 4 illustrates an example financial services computing system included as part of the financial services platform.

### DESCRIPTION OF EXAMPLE EMBODIMENTS

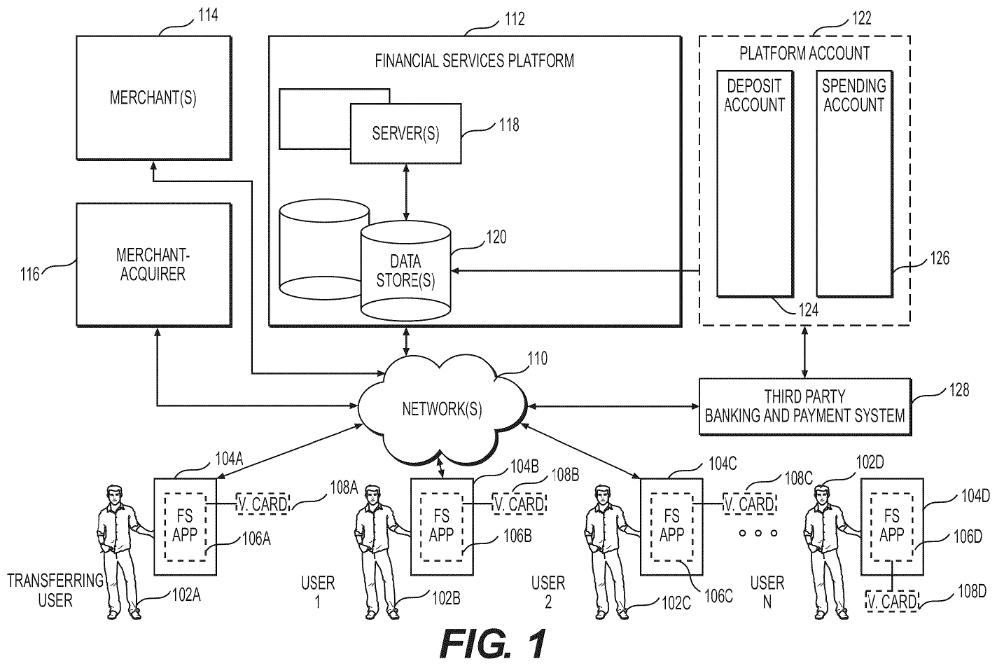

FIG. 1 illustrates a financial services platform and network environment 100 that may be utilized for dynamically guiding users to request valid payments, in accordance with the presently disclosed embodiments. As depicted, in certain embodiments, the financial services platform and network environment 100 may include a number of users 102A (e.g., “Transferring User”), 102B (e.g., “User 1”), 102C (e.g., “User 2”), and 102D (e.g., “User N”) that may be associated with respective mobile electronic devices 104A, 104B, 104C, and 104D. In certain embodiments, the respective mobile electronic devices 104A, 104B, 104C, and 104D may be utilized for executing respective instances of financial services applications 106A, 106B, 106C, and 106D (e.g., which may be each associated with and serviced by a financial services platform 112 via one or more networks 110).

In certain embodiments, as further depicted by FIG. 1, each of the respective instances of financial services applications 106A, 106B, 106C, and 106D executing on the respective mobile electronic devices 104A, 104B, 104C, and 104D may be associated with virtual spending cards 108A, 108B, 108C, and 108D. In certain embodiments, the virtual spending cards 108A, 108B, 108C, and 108D may be utilized to execute point-of-sale (PoS) transactions or other transactions with one or more merchants 114. For example, in certain embodiments, the respective mobile electronic devices 104A, 104B, 104C, and 104D may exchange electronic data associated with the virtual spending cards 108A, 108B, 108C, and 108D over the one or more networks 110 with a payment processor of a merchant-acquirer 116 associated with the one or more merchants 114. For example, in certain embodiments, the merchant-acquirer 116 may be suitable for settling credit card transactions between the one or more merchants 114 and the number of users 102A (e.g., “Transferring User”), 102B (e.g., “User 1”), 102C (e.g., “User 2”), and 102D (e.g., “User N”). In other embodiments, the virtual spending cards 108A, 108B, 108C, and 108D may be utilized to execute payments between the number of users 102A (e.g., “Transferring User”), 102B (e.g., “User 1”), 102C (e.g., “User 2”), and 102D (e.g., “User N”).

In certain embodiments, as further depicted by FIG. 1, the respective mobile electronic devices 104A, 104B, 104C, and 104D may be coupled via the one or more networks 110 to the financial services platform 112. In certain embodiments, the financial services platform 112 may include, for example, a cloud-based computing architecture suitable for hosting and servicing the respective instances of financial services applications 106A, 106B, 106C, and 106D executing on the respective mobile electronic devices 104A, 104B, 104C, and 104D. For example, in one embodiment, the financial services platform 112 may include a Platform as a Service (PaaS) architecture, a Software as a Service (SaaS) architecture, a Compute as a Service (CaaS) architecture, an Infrastructure as a Service (IaaS) architecture, a Data as a Service (DaaS) architecture, a Database as a Service (DBaaS) architecture, or other similar cloud-based computing architecture (e.g., “X” as a Service (XaaS)).

In certain embodiments, as further depicted by FIG. 1, the financial services platform 112 may include one or more computer server(s) 118 and one or more data stores(s) 120. For example, in some embodiments, the computer server(s) 118 may include one or more general purpose processors, one or more graphic processing units (GPUs), one or more application-specific integrated circuits (ASICs), one or more system-on-chips (SoCs), one or more microcontrollers, one or more field-programmable gate arrays (FPGAs), or any other processing device(s) that may be suitable for providing processing and/or computing support for the respective instances of financial services applications 106A, 106B, 106C, and 106D executing on the respective mobile electronic devices 104A, 104B, 104C, and 104D. Similarly, the data stores(s) 120 may include, for example, one or more internal databases that may be utilized to store information (e.g., user profile data, user account data, user transaction data, user financial data, and so forth) associated with the number of users 102A (e.g., “Transferring User”), 102B (e.g., “User 1”), 102C (e.g., “User 2”), and 102D (e.g., “User N”).

In certain embodiments, as further depicted by FIG. 1, the one or more computer server(s) 118 may generate a platform account 122 that may be stored to the one or more data stores(s) 120. In certain embodiments, the platform account 122, which may be owned, for example, by a transferring user (e.g., user 102A Transferring User), may include a deposit account 124 and a credit spending account 126. In certain embodiments, the deposit account 124 may be utilized to hold funds as collateral to secure repayment of balances corresponding to the credit spending account 126. In certain embodiments, individual spending and/or deposit accounts associated with each of the number of users 102B (e.g., “User 1”), 102C (e.g., “User 2”), and 102D (e.g., “User N”).

In certain embodiments, the number of users 102B (e.g., “User 1”), 102C (e.g., “User 2”), and 102D (e.g., “User N”) may include one or more potential recipient users that may be selected to receive, for example, one or more payments from a transferring user 102A (e.g., “Transferring User”), or vice-versa. For example, as previously noted, the number of users 102B (e.g., “User 1”), 102C (e.g., “User 2”), and 102D (e.g., “User N”) may each own an independent and individual platform account 122 that may include a deposit account 124 and a credit spending account 126. In certain embodiments, the platform account 122 corresponding, for example, to the transferring user 102A (e.g., “Transferring User”), may also be connected to one or more third-party accounts 128 (e.g., a third-party banking account, a third-party credit account, a third-party investment account), which may be utilized to execute payments to one or more of the number of users 102B (e.g., “User 1”), 102C (e.g., “User 2”), and 102D (e.g., “User N”) in accordance with the present embodiments. In one embodiment, the one or more third-party accounts 128 (e.g., a third-party banking account, a third-party credit account, a third-party investment account) may include only third-party accounts in which the financial services platform 112 may verify an amount of funds or credit that may be associated with the one or more third-party accounts 128 (e.g., a third-party banking account, a third-party credit account, a third-party investment account).

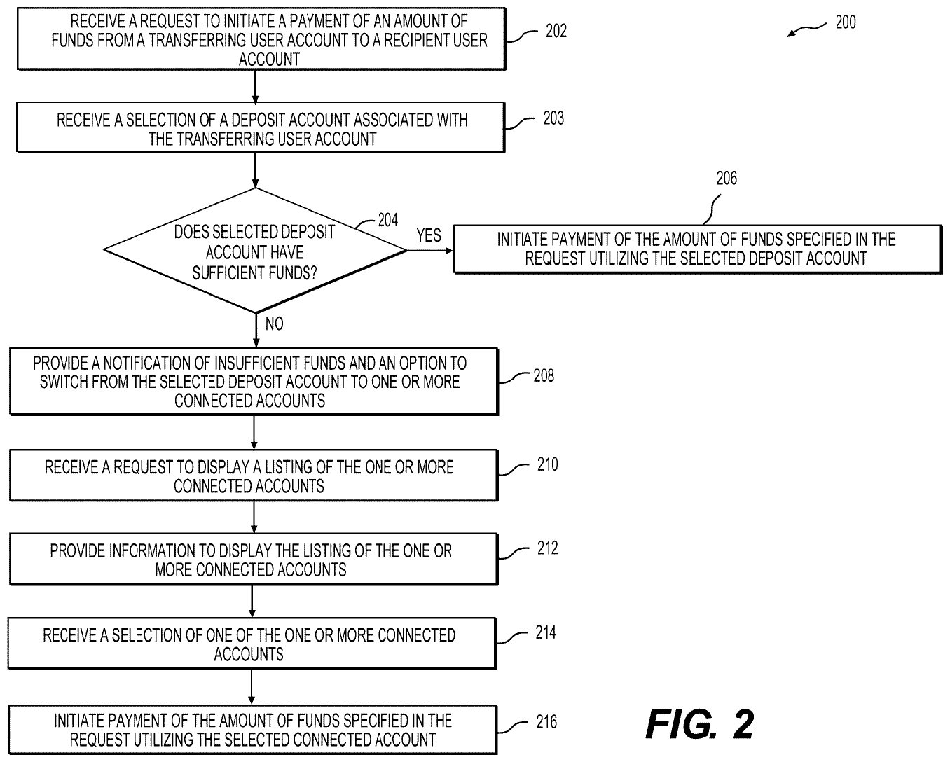

FIG. 2 illustrates a flow diagram of a method 200 for dynamically guiding users to request valid payments, in accordance with the presently disclosed embodiments. The method 200 may be performed utilizing one or more processing devices (e.g., electronic devices 104A, 104B or financial services platform 112) that may include hardware (e.g., a general purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), or any other processing device(s) that may be suitable for processing user data, financial data, market data, transaction data, and so forth), software (e.g., instructions running/executing on one or more processors), firmware (e.g., microcode), or some combination thereof.

The method 200 may begin block 202 with the one or more processing devices (e.g., electronic devices 104A, 104B or financial services platform 112) receiving, from a first instance of an application executing on a first electronic device associated with a transferring user, a first request to initiate a payment of an amount of funds from a transferring user account to a recipient user account with a financial services platform. In one embodiment, the application may be associated with the financial services platform, and the transferring user account may include a deposit account (e.g., deposit account 124) configured to hold funds. The method 200 may then continue at block 203 with the one or more processing devices (e.g., electronic devices 104A, 104B or financial services platform 112) determining whether the first request to initiate the payment of the amount of funds can be satisfied by at least a portion of the funds held in the deposit account. In certain embodiments, in response to determining at decision 204 that the payment of the amount of funds can be satisfied by at least the portion of the funds held in the deposit account, the method 200 may continue at block 206 with the one or more processing devices (e.g., electronic devices 104A, 104B or financial services platform 112) initiating the requested payment to the recipient user account in accordance with a value of the amount of funds.

On the other hand, in response to determining at decision 204 that the payment of the amount of funds cannot be satisfied by at least the portion of the funds held in the deposit account, the method 200 may continue at block 208 with the one or more processing devices (e.g., electronic devices 104A, 104B or financial services platform 112) providing a second request to the first electronic device associated with the transferring user, in which the second request corresponds to a notification that the deposit account includes insufficient funds and an option to switch from the deposit account to one or more connected accounts associated with the transferring user account. In certain embodiments, the method 200 may continue at block 210 with the one or more processing devices (e.g., electronic devices 104A, 104B or financial services platform 112) receiving, from the first instance of the application executing on the first electronic device associated with the transferring user, a confirmation to switch from the deposit account to the one or more connected accounts.

In certain embodiments, in response to receiving the confirmation to switch from the deposit account to the one or more connected accounts, the method 200 may continue at block 212 with the one or more processing devices (e.g., electronic devices 104A, 104B or financial services platform 112) causing the first instance of the application executing on the first electronic device associated with the transferring user to display a listing of the one or more connected accounts. In certain embodiments, in response to receiving a selection of at least one connected account of the listing of the one or more connected accounts, the method 200 may continue at block 214 with the one or more processing devices (e.g., electronic devices 104A, 104B or financial services platform 112) receiving a selection of one of the one or more connected accounts and determining whether the first request to initiate the payment of the amount of funds can be satisfied by at least a portion of funds held in the at least one selected connected account. In certain embodiments, in response to determining that the request for the amount of funds can be satisfied by at least the portion of the funds held in the at least one selected connected account, the method 200 may conclude at block 216 with the one or more processing devices (e.g., electronic devices 104A, 104B or financial services platform 112) initiating the payment from the transferring user to the recipient user account in accordance with a value of the amount of funds.

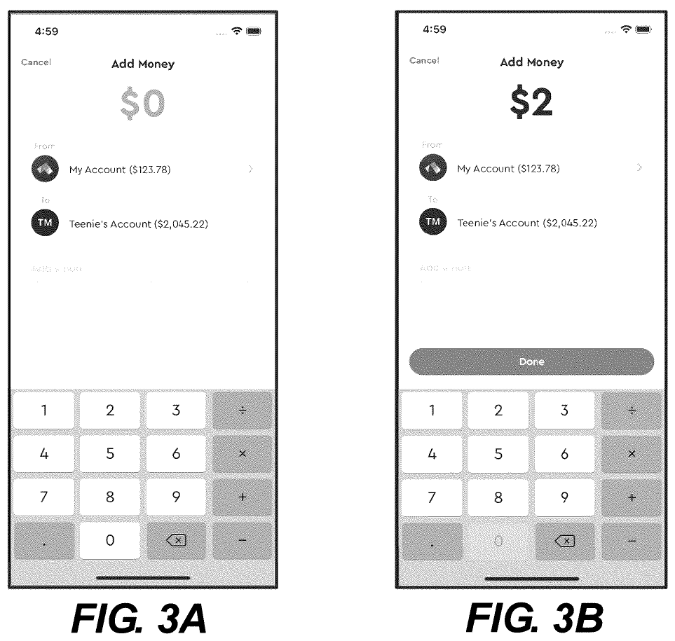

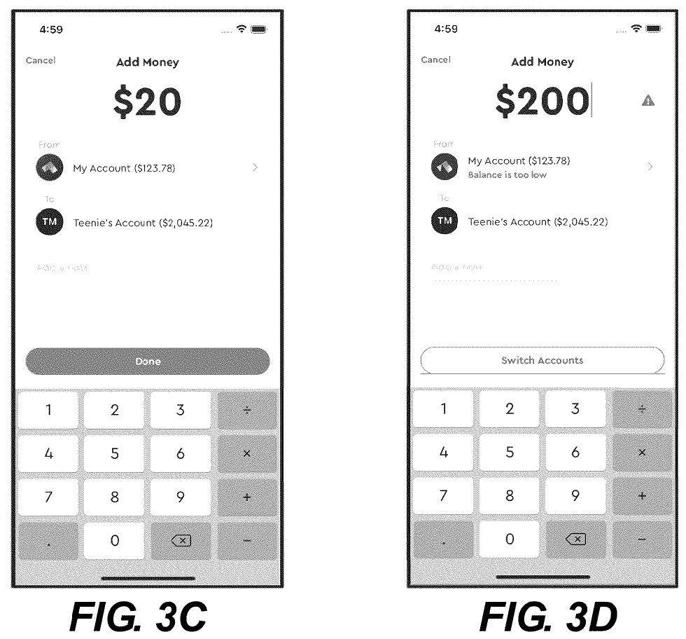

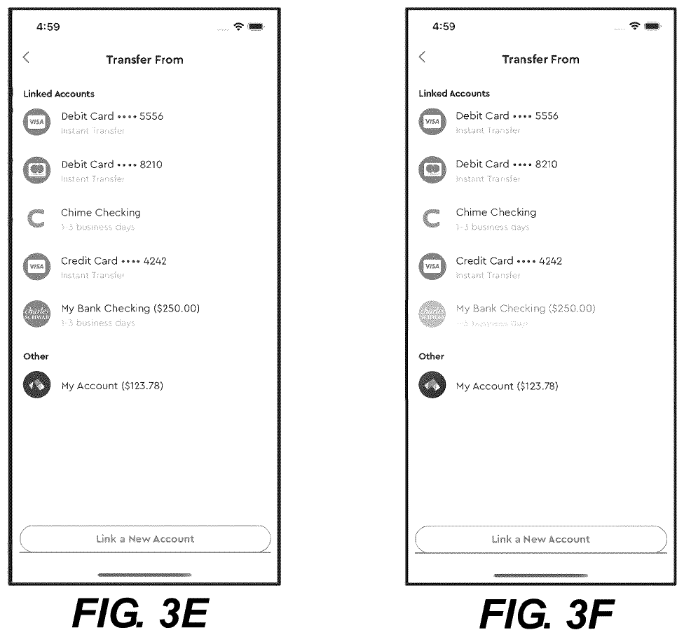

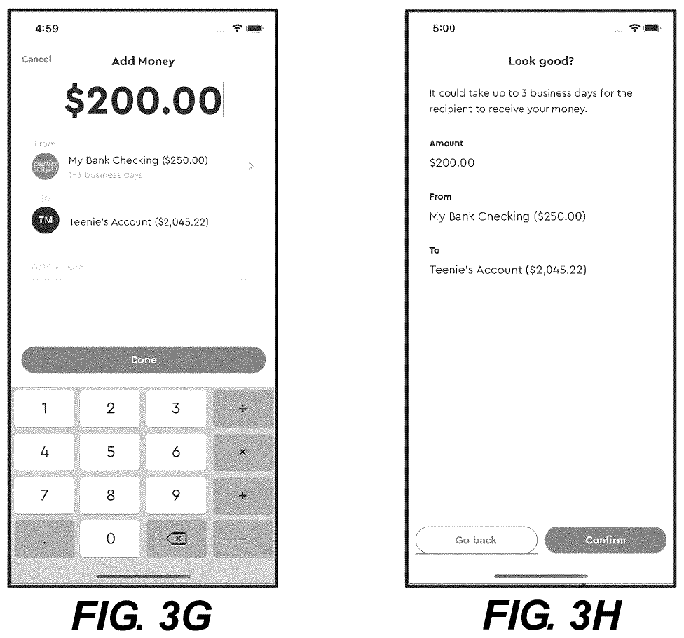

FIGS. 3A-3H illustrate one or more running examples of a financial services platform for dynamically guiding users to request valid payments, in accordance with the presently disclosed embodiments. As depicted by a user interface of FIG. 3A, a user may launch a financial services application on a mobile electronic device, for example, and may perform one or more user inputs corresponding to a request to execute a payment to a recipient user. In one embodiment, the recipient user may be another user of the financial services platform that may be previously unassociated with the user. In another embodiment, the recipient user may be one or more users associated with the user, such as friends or personal acquaintances of the user.

As depicted by a user interface of FIG. 3B, the user may begin inputting a value of an amount of funds to transfer to the recipient user. For example, as depicted by FIG. 3B, the user, desiring to transfer an amount of funds totaling $200 to the recipient user, may begin by inputting a value of “2.” In certain embodiments, while the user is inputting the value of the desired amount of funds to transfer (e.g., $200), the financial services platform may concurrently determine whether the desired amount of funds to transfer can be satisfied, for example, by funds held in a deposit account of the user. In certain embodiments, for as long as the inputted value of the desired amount of funds to transfer (e.g., “$2”) is less than or equal to a value of an amount of funds that can be satisfied by funds held in the deposit account of the user (e.g., “$123.78”), the user interface may display a “Done” affordance, as further depicted in the user interface of FIG. 3B.

For example, the “Done” affordance may correspond to an affordance that may be selected by the user to confirm that the user, for example, has selected the correct recipient and has completed inputting the value of the desired amount of funds to transfer (e.g., $200). For example, as depicted by a user interface of FIG. 3C, the user may continue by inputting a value of “0,” such that the total value of the desired amount of funds to transfer momentarily constitutes “$20.” The user interface may maintain display of “Done” affordance, as further depicted in the user interface of FIG. 3B. As depicted by a user interface of FIG. 3D, the user may continue by inputting another value of “0,” such that the total value of the desired amount of funds to transfer now constitutes “$200.” In certain embodiments, in response to the financial services platform determining that the inputted value of the desired amount of funds to transfer (e.g., “$200”) cannot be satisfied by funds held in the deposit account of the user (e.g., “$123.78”), the previously displayed “Done” affordance may be dynamically replaced by a “Switch Accounts” affordance as further illustrated by the user interface of FIG. 3D.

In certain embodiments, the “Switch Accounts” affordance may correspond to an affordance that may be selected by the user to confirm that the user desires to switch from utilizing the deposit account of the user to execute the desired payment to utilizing one or more connected accounts (e.g., linked third-party banking account owned by the user, linked third-party credit card account owned by the user, linked mobile payment account owned by the user) to execute the desired payment. As depicted by a user interface of FIG. 3E, in response to the user selecting the “Switch Accounts” affordance, a selectable listing of one or more connected accounts (e.g., linked third-party banking account owned by the user, linked third-party credit card account owned by the user, linked mobile payment account owned by the user) associated with the user may be displayed. A “Link a New Account” affordance for allowing the user to link additional third-party accounts may also be displayed.

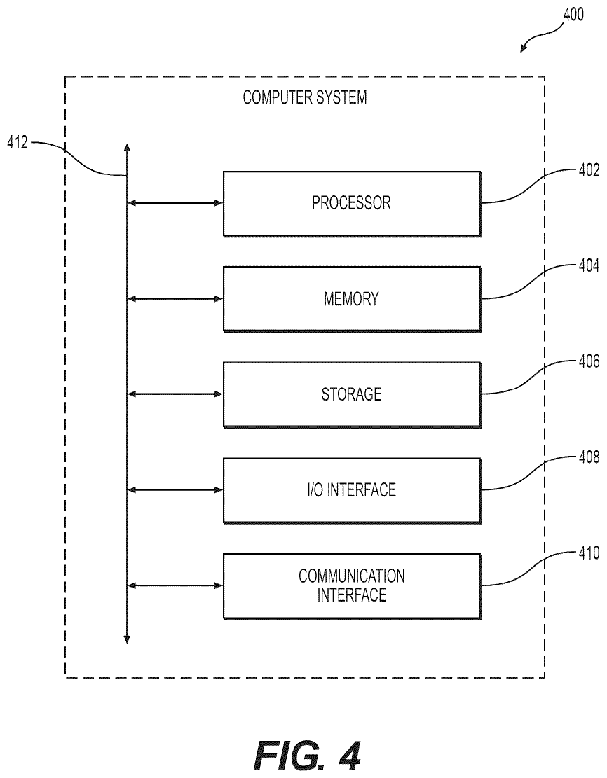

As depicted by a user interface of FIG. 3F, the user may select “My Bank Checking” connected account from the displayed selectable listing of one or more connected accounts associated with the user. As depicted by a user interface of FIG. 3G, the inputted value of the desired amount of funds to transfer (e.g., “$200”) may be displayed along with the selected “My Bank Checking” connected account and the recipient user. As further by the user interface of FIG. 3G, the “Done” affordance may be then redisplayed. For example, because the financial services platform has determined that the inputted value of the desired amount of funds to transfer (e.g., “$200”) is less than or equal to a value of an amount of funds that can be satisfied by funds held in the selected “My Bank Checking” connected account (e.g., “$250.00”), the user interface may redisplay the “Done” affordance for the user to confirm the desired payment. As depicted by a user interface of FIG. 4H, a final confirmation user interface may be displayed, including a “Confirm” affordance for the user to select to finalize and execute the desired payment.

FIG. 4 illustrates an example financial services computing system 400 (which may be included as part of the financial services platform 112) that may be utilized for dynamically guiding users to request valid payments, in accordance with the presently disclosed embodiments. In certain embodiments, one or more financial services computing system 400 perform one or more steps of one or more methods described or illustrated herein. In certain embodiments, one or more financial services computing system 400 provide functionality described or illustrated herein. In certain embodiments, software running on one or more financial services computing system 400 performs one or more steps of one or more methods described or illustrated herein or provides functionality described or illustrated herein. Certain embodiments include one or more portions of one or more financial services computing system 400. Herein, reference to a computer system may encompass a computing device, and vice versa, where appropriate. Moreover, reference to a computer system may encompass one or more computer systems, where appropriate.

This disclosure contemplates any suitable number of financial services computing systems 400. This disclosure contemplates computer system 400 taking any suitable physical form. As example and not by way of limitation, computer system 400 may be an embedded computer system, a system-on-chip (SOC), a single-board computer system (SBC) (e.g., a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more financial services computing system 400; be unitary or distributed; span multiple locations; span multiple machines; span multiple data centers; or reside in a cloud, which may include one or more cloud components in one or more networks.

Where appropriate, one or more financial services computing system 400 may perform without substantial spatial or temporal limitation one or more steps of one or more methods described or illustrated herein. As an example, and not by way of limitation, one or more financial services computing system 400 may perform in real time or in batch mode one or more steps of one or more methods described or illustrated herein. One or more financial services computing system 400 may perform at different times or at different locations one or more steps of one or more methods described or illustrated herein, where appropriate.

In certain embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement. In certain embodiments, processor 402 includes hardware for executing instructions, such as those making up a computer program. As an example, and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In certain embodiments, processor 402 may include one or more internal caches for data, instructions, or addresses. This disclosure contemplates processor 402 including any suitable number of any suitable internal caches, where appropriate. As an example, and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402.

Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In certain embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In certain embodiments, memory 404 includes main memory for storing instructions for processor 402 to execute or data for processor 402 to operate on. As an example, and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In certain embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere).

One or more memory buses (which may each include an address bus and a data bus) may couple processor 402 to memory 404. Bus 412 may include one or more memory buses, as described below. In certain embodiments, one or more memory management units (MMUs) reside between processor 402 and memory 404 and facilitate accesses to memory 404 requested by processor 402. In certain embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memory devices 404, where appropriate. Although this disclosure describes and illustrates particular memory, this disclosure contemplates any suitable memory.

In certain embodiments, storage 406 includes mass storage for data or instructions. As an example, and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In certain embodiments, storage 406 is non-volatile, solid-state memory. In certain embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In certain embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example, and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 406 for them. Where appropriate, I/O interface 408 may include one or more device or software drivers enabling processor 402 to drive one or more of these I/O devices. I/O interface 408 may include one or more I/O interfaces 406, where appropriate. Although this disclosure describes and illustrates a particular I/O interface, this disclosure contemplates any suitable I/O interface.

In certain embodiments, communication interface 410 includes hardware, software, or both providing one or more interfaces for communication (such as, for example, packet-based communication) between computer system 400 and one or more other computer systems 400 or one or more networks. As an example, and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it.

As an example, and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In certain embodiments, bus 412 includes hardware, software, or both coupling components of computer system 400 to each other. As an example, and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, “automatically” and its derivatives means “without human intervention,” unless expressly indicated otherwise or indicated otherwise by context.

The embodiments disclosed herein are only examples, and the scope of this disclosure is not limited to them. Embodiments according to this disclosure are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates certain embodiments as providing particular advantages, certain embodiments may provide none, some, or all of these advantages.

What is claimed is:

1. A method, comprising, by one or more computer servers associated with a financial services platform:
receiving, by the one or more computer servers, and from a first instance of an application executing on a first electronic device associated with a first user, a first request to initiate a payment of an amount of funds from a transferring user account to a recipient user account with the financial services platform, wherein the application is associated with the financial services platform, and wherein the transferring user account comprises a deposit account configured to hold funds;
determining, by the one or more computer servers, whether the first request to initiate the payment of the amount of funds can be satisfied by at least a portion of the funds held in the deposit account; and
in response to determining that the payment of the amount of funds cannot be satisfied by at least the portion of the funds held in the deposit account:
providing, by the one or more computer servers, a second request to the first electronic device associated with the first user, the second request corresponding to a prompt to switch from the deposit account to one or more connected accounts associated with the transferring user account; and
receiving, by the one or more computer servers, and from the first instance of the application executing on the first electronic device associated with the first user, a confirmation to switch from the deposit account to the one or more connected accounts;
in response to receiving the confirmation to switch from the deposit account to the one or more connected accounts, causing, by the one or more computer servers, the first instance of the application executing on the first electronic device associated with the first user to display a listing of the one or more connected accounts; and
in response to receiving a selection of at least one connected account of the listing of the one or more connected accounts:
determining, by the one or more computer servers, whether the first request to initiate the payment of the amount of funds can be satisfied by at least a portion of funds held in the at least one selected connected account; and
in response to determining that the request for the amount of funds can be satisfied by at least the portion of the funds held in the at least one selected connected account, updating, by the one or more computer servers, the recipient user account in accordance with a value of the amount of funds.

2. The method of claim 1, further comprising:
in response to determining that the payment of the amount of funds can be satisfied by at least the portion of the funds held in the deposit account, updating, by the one or more computer servers, the transferring user account and the recipient user account to reflect:
an increase in a balance of the recipient user account in accordance with a value of the amount of funds to satisfy the payment of the amount of funds; and
a decrease in the balance of the deposit account in accordance with the value of the amount of funds to satisfy the payment of the amount of funds.

3. The method of claim 1, further comprising:
in response to determining that the request for the amount of funds cannot be satisfied by at least the portion of the funds held in the at least one selected connected account:
providing, by the one or more computer servers, a third request to the first electronic device associated with the first user, the third request corresponding to a prompt to switch from the at least one selected connected account to another one of the one or more connected accounts; and
receiving, by the one or more computer servers, and from the first instance of the application executing on the first electronic device associated with the first user, a confirmation to switch from the at least one selected connected account to another one of the one or more connected accounts.

4. The method of claim 3, further comprising:
in response to receiving the confirmation to switch from the at least one selected connected account to another one of the one or more connected accounts, causing, by the one or more computer servers, the first instance of the application executing on the first electronic device to redisplay the listing of the one or more connected accounts.

5. The method of claim 1, further comprising:
prior to receiving the first request to initiate the payment of the amount of funds, causing, by the one or more computer servers, the first instance of the application executing on the first electronic device associated with the first user to display a first affordance configured to cause the payment of the amount of funds to be initiated in response to a selection by the first user.

6. The method of claim 5, further comprising:
while the first user inputs a value of funds corresponding to the first request to initiate the payment of the amount of funds:
determining, by the one or more computer servers, and based on the inputted value of funds, whether the first request to initiate the payment of the amount of funds can be satisfied by at least a portion of the funds held in the deposit account; and
in response to determining that the payment of the amount of funds cannot be satisfied by at least the portion of the funds held in the deposit account, causing, by the one or more computer servers, the first instance of the application executing on the first electronic device associated with the first user to display a second affordance in place of the first affordance.

7. The method of claim 6, wherein the second affordance corresponds to the prompt to switch from the deposit account to the one or more connected accounts associated with the transferring user account.

8. The method of claim 7, further comprising:
while the first user inputs a value of funds corresponding to the first request to initiate the payment of the amount of funds:
determining, by the one or more computer servers, and based on the inputted value of funds, whether the first request to initiate the payment of the amount of funds can be satisfied by at least a portion of the funds held in the deposit account; and
in response to determining that the payment of the amount of funds can be satisfied by at least the portion of the funds held in the deposit account, causing, by the one or more computer servers, the first instance of the application executing on the first electronic device associated with the first user to maintain display of the first affordance.

9. The method of claim 7, further comprising:
receiving, by the one or more computer servers, and from the first instance of the application executing on the first electronic device associated with the first user, a selection of the first affordance, the selection of the first affordance corresponding to a confirmation of a completion of an input of a value of funds corresponding to the first request to initiate the payment of the amount of funds.

10. The method of claim 9, further comprising:
in response to receiving the selection of the first affordance, causing, by the one or more computer servers, the first instance of the application executing on the first electronic device to display a third affordance, the third affordance corresponding to a confirmation to initiate the payment of the amount of funds from the transferring user account to the recipient user account.

11. The method of claim 9, further comprising:
in response to receiving the selection of the first affordance, causing, by the one or more computer servers, the first instance of the application executing on the first electronic device to display a fourth affordance, the fourth affordance corresponding to a confirmation to forgo initiating the payment of the amount of funds from the transferring user account to the recipient user account.

12. The method of claim 1, wherein updating the recipient user account in accordance with the value of the amount of funds comprises updating a deposit account associated the recipient user account.

13. The method of claim 12, further comprising updating the deposit account associated the recipient user account to reflect an increase in a balance of the deposit account associated the recipient user account in accordance with the value of the amount of funds.

14. The method of claim 1, wherein the one or more connected accounts comprises one or more connected banking accounts or credit card accounts owned by the first user.

15. The method of claim 1, further comprising:
prior to updating the recipient user account in accordance with the value of the amount of funds, receiving, by the one or more computer servers, a confirmation to initiate the payment of the amount of funds from the transferring user account to the recipient user account.

16. One or more computer servers associated with a financial services platform, comprising:
one or more non-transitory computer-readable storage media including instructions; and
one or more processors coupled to the one or more storage media, the one or more processors configured to execute the instructions to:
receive from a first instance of an application executing on a first electronic device associated with a first user, a first request to initiate a payment of an amount of funds from a transferring user account to a recipient user account with the financial services platform, wherein the application is associated with the financial services platform, and wherein the transferring user account comprises a deposit account configured to hold funds;
determine whether the first request to initiate the payment of the amount of funds can be satisfied by at least a portion of the funds held in the deposit account; and
in response to determining that the payment of the amount of funds cannot be satisfied by at least the portion of the funds held in the deposit account:
provide a second request to the first electronic device associated with the first user, the second request corresponding to a prompt to switch from the deposit account to one or more connected accounts associated with the transferring user account;
receive from the first instance of the application executing on the first electronic device associated with the first user, a confirmation to switch from the deposit account to the one or more connected accounts;
in response to receiving the confirmation to switch from the deposit account to the one or more connected accounts, cause the first instance of the application executing on the first electronic device associated with the first user to display a listing of the one or more connected accounts; and
in response to receiving a selection of at least one connected account of the listing of the one or more connected accounts:
determine whether the first request to initiate the payment of the amount of funds can be satisfied by at least a portion of funds held in the at least one selected connected account; and
in response to determining that the request for the amount of funds can be satisfied by at least the portion of the funds held in the at least one selected connected account, update the recipient user account in accordance with a value of the amount of funds.

17. The one or more computer servers of claim 16, wherein the instructions further comprise instructions to:
in response to determining that the payment of the amount of funds can be satisfied by at least the portion of the funds held in the deposit account, update the transferring user account and the recipient user account to reflect:
an increase in a balance of the recipient user account in accordance with a value of the amount of funds to satisfy the payment of the amount of funds; and
a decrease in the balance of the deposit account in accordance with the value of the amount of funds to satisfy the payment of the amount of funds.

18. The one or more computer servers of claim 16, wherein the instructions further comprise instructions to:
in response to determining that the request for the amount of funds cannot be satisfied by at least the portion of the funds held in the at least one selected connected account:
provide a third request to the first electronic device associated with the first user, the third request corresponding to a prompt to switch from the at least one selected connected account to another one of the one or more connected accounts; and
receive, from the first instance of the application executing on the first electronic device associated with the first user, a confirmation to switch from the at least one selected connected account to another one of the one or more connected accounts.

19. The one or more computer servers of claim 18, wherein the instructions further comprise instructions to:
in response to receiving the confirmation to switch from the at least one selected connected account to another one of the one or more connected accounts, cause the first instance of the application executing on the first electronic device to redisplay the listing of the one or more connected accounts.

20. A non-transitory computer-readable medium comprising instructions that, when executed by one or more computer servers associated with a financial services platform, cause the one or more computer servers to:
receive from a first instance of an application executing on a first electronic device associated with a first user, a first request to initiate a payment of an amount of funds from a transferring user account to a recipient user account with the financial services platform, wherein the application is associated with the financial services platform, and wherein the transferring user account comprises a deposit account configured to hold funds;
determine whether the first request to initiate the payment of the amount of funds can be satisfied by at least a portion of the funds held in the deposit account; and
in response to determining that the payment of the amount of funds cannot be satisfied by at least the portion of the funds held in the deposit account:
provide a second request to the first electronic device associated with the first user, the second request corresponding to a prompt to switch from the deposit account to one or more connected accounts associated with the transferring user account;
receive from the first instance of the application executing on the first electronic device associated with the first user, a confirmation to switch from the deposit account to the one or more connected accounts;
in response to receiving the confirmation to switch from the deposit account to the one or more connected accounts, cause the first instance of the application executing on the first electronic device associated with the first user to display a listing of the one or more connected accounts; and
in response to receiving a selection of at least one connected account of the listing of the one or more connected accounts:
determine whether the first request to initiate the payment of the amount of funds can be satisfied by at least a portion of funds held in the at least one selected connected account; and
in response to determining that the request for the amount of funds can be satisfied by at least the portion of the funds held in the at least one selected connected account, update the recipient user account in accordance with a value of the amount of funds.
